(19) United States
(12) Patent Application Publication
(10) Pub. No.: US 2010/0061424 A1
(43) Pub. Date: Mar. 11, 2010

(54) Spread Spectrum Controller with Bit Error Rate Feedback

(75) Inventors: Philip Raymond Germann, Oronoco, MN (US); Mark James Jeanson, Rochester, MN (US); Jordan Ross Keuseman, Rochester, MN (US); Dennis James Wurth, Rochester, MN (US); George Russell Zettles, IV, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, Armonk, NY (US)

(21) Appl. No.: 12/206,983

(22) Filed: Sep. 9, 2008

(51) Int. Cl. H04B 1/69

(52) U.S. Cl. 375/130; 375/E01.001

(57) ABSTRACT

A spread spectrum controller that adjusts frequency range subject to a bit error rate (BER). Measuring the bit error rate (BER) at different clock frequency ranges and comparing the BER to a BER threshold. Narrowing or widening the clock frequency range based on whether the BER is above or below the BER threshold to optimize a system for both performance and compliance.

### FIELD OF THE INVENTION

This invention relates generally to the use of spread spectrum clocking for lowering the amplitude of the measured emissions at fundamental or harmonic frequencies. Particularly, this invention relates to improving how the level of clock spreading is set in order to comply with regulatory requirements.

### BACKGROUND OF THE INVENTION

In 1975 the Federal Communications Commission (FCC) enacted regulations to control equipment that radiated undesired RF energy such as televisions, automobiles, and low-power, unregulated RF radiators such as remote controls and walkie-talkies. The purpose of these regulations was to deal with the problem of cross interference between a range of electronic devices from microwave ovens to cell phones which had proliferated during the 1980's and 1990's.

Designers and manufacturers of these electronic devices have been constantly challenged to satisfy the regulatory requirements for electromagnetic emissions established by the FCC. In the past, designers relied on containment techniques for reducing radiated emissions. A personal computer used its grounded steel cabinet as a shield to intercept and dissipate the energy radiated by the motherboard. However, as electronics became increasingly smaller, containment techniques became more difficult. At the root of the problem was the system's clock. Higher clock speeds and associated harmonics resulted in energy spikes along a single frequency. Subsequent design techniques such as shielding, EMI filtering, and careful circuit layout became costly and more difficult as electronics shrunk.

Today, variable spread spectrum components are used to vary clock frequency to spread energy across a frequency domain. Variable spread spectrum components can vary the clock to be spread wide or narrow depending on design requirements. Adjusting the level of spread on these components is typically done by changing on card resistors or changing the software settings in a spread spectrum chip to one of several pre-defined granular settings. However, these techniques and others currently available still involve considerable complexity, effort, and user involvement.

The shortcomings of current techniques become clear as designers set out to balance the need to widen the clock spread to satisfy regulations with the need to keep the bit error rate (BER) below a certain threshold to provide reliable data transfer. Mature design processes include ways to reduce emissions from a system early in the design cycle by incorporating input from EMC engineers into the physical design of a card or system. However, even in the current design environment, card and system packagers, and back-end testers can be surprised by violations of regulated emissions. Engineers are frequently left clambering to find a way to correct the violation while preventing breakage and often adopt a trial-and-error approach to changing spread spectrum settings.

Therefore, there is a need for an apparatus and method tailored to dealing with the tradeoff between regulatory compliance and minimal BER. Further, it would be desirable to know the spread limit at which an interface breaks to be able to more quickly proceed to other methods of insuring compliance once it has become clear that the efficacy of clock spreading has been exhausted.

### SUMMARY OF THE INVENTION

The present invention provides a method and apparatus for balancing the BER of an interface with a spreading function to optimize a system for both reliable data transfer and compliance. In addition, the present invention allows for the further reduction of RF emissions even if a system is already in compliance.

An apparatus is configured to adjust a spread spectrum range on a clock subject to bit error rate. In an embodiment, the apparatus comprises a data interface system, a compare logic unit, and a spread control unit. The data interface system is configured to measure the BER and the compare logic unit configured to compare the output of the data interface system to a BER threshold. The spread control unit is coupled to the compare logic unit whose output controls the spread control unit and consequently controls the clock frequency range. A method for maximizing spread spectrum on a clock subject to BER is also provided.

### BRIEF DESCRIPTION OF THE DRAWINGS

FIG. 1 shows two graphs, the top is of a radiated emissions spectrum with an FCC limit depicted and the bottom of the BER at different clock spread spectrum settings.

FIG. 2A shows a high level view of the components of the invention including the data interface system, the wrap back logic unit, and the control logic unit.

FIG. 2B shows an embodiment of a data interface system design for testing the BER using a “wrap-back” test.

FIG. 2C shows an embodiment of a data interface system design for testing the BER using a “wrap-back” design operating in parallel with a circuit logic component.

FIG. 2D shows the control logic unit and data interface system of FIG. 2A in greater detail.

FIG. 3 illustrates a flowchart of a method embodiment of the invention.

FIG. 4 illustrates a flowchart of an alternative embodiment of FIG. 3 with an added reset step.

### DETAILED DESCRIPTION OF THE PREFERRED EMBODIMENTS

In the following detailed description of the preferred embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention.

Today, in order to comply with FCC requirements for electromagnetic emissions, designers of systems use spread-spectrum circuitry to vary the clock signal across a range of frequencies. Varying the frequency of the clock has the effect of spreading the energy across a frequency domain. For example, if a system's processors operate at 750 MHz, then that frequency and its harmonics are likely to show up as a spike on a radiated emissions spectrum. Spread-spectrum clocking skews the frequency of the clock very slightly over time, thereby “spreading” the energy of the period signal across a wider band of frequencies. Thus, the frequencies of the clock will appear to have 748, 748.5, 749, 749.5, 750, 750.5, 751, 751.5, and 752 MHz during different periods. This has the net effect of lowering the amplitude of the measured emissions at the fundamental or harmonic frequencies below the regulatory requirements.

The tradeoff with spread spectrum clock variation is that high-speed data interfaces require clean, precise clocks to insure the alignment of the clock with the data at the receiver which becomes more difficult as clock spread range widens. In other words, widening the spread of the clock increases a BER associated with a data transmission. Larger systems designed with common clocks have been particularly susceptible to higher BER as the clock spread range widens.

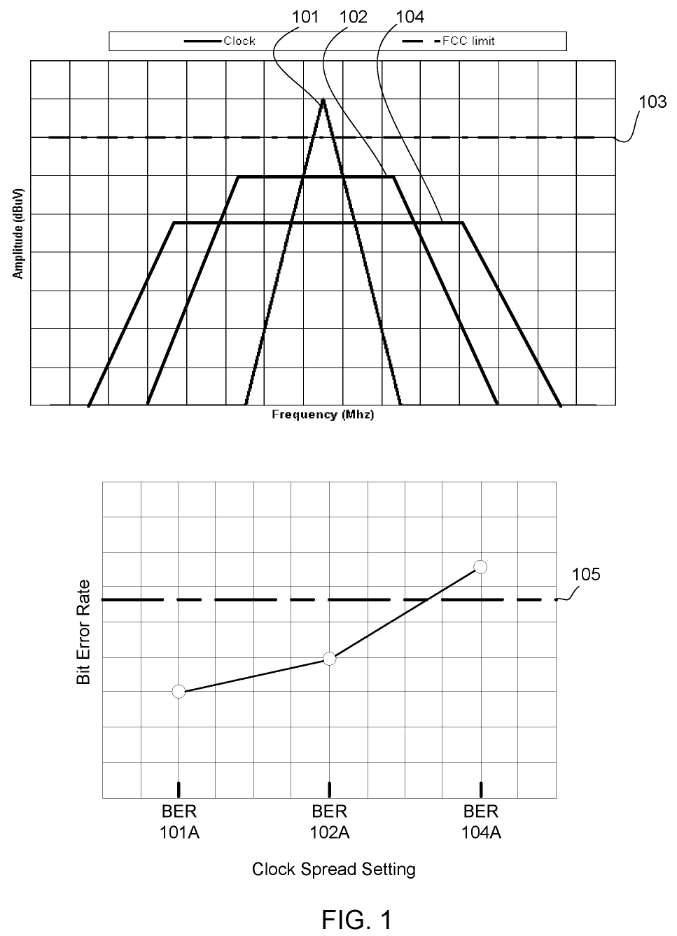

FIG. 1 illustrates the aforementioned tradeoff between clock signal spreading and BER. FIG. 1 shows two graphs, the radiated emissions of signals at different clock spread settings, shown in the top graph, and the associated BER of those signals, shown in the bottom graph. The radiation spike 101 illustrates the RF energy radiated from an electronic device without spread spectrum functionality or with the spread spectrum function turned off. The device's clock produces a radiation spike at the clock's center frequency. An associated BER measurement 101A reflects the BER for an electronic system without clock spreading measured in error bits per total bits transmitted. As illustrated the BER measurement 101A is below the BER threshold 105 which reflects the maximum acceptable level of BER for the electronic system. Also as illustrated, the peak amount of energy radiated at one frequency is above the FCC maximum specified value 103 for a particular frequency.

The spread clock frequency 102 illustrates the reduction in the peak amount of energy radiated at one particular frequency and spread across multiple frequencies. The spreading of clock frequency reduces the peak radiated emissions at a particular frequency to below the FCC maximum specified value 103. Although the peak amount of energy is spread across multiple frequencies, the associated BER measurement 102A increases when clock spreading is introduced. Nonetheless, the BER measurement 102A remains below the BER threshold 105. A further widening of the spread clock frequency range 104 results in an even greater associated BER measurement 104A above the BER threshold 105 which exceeds the maximum acceptable level of BER for the electronic system.

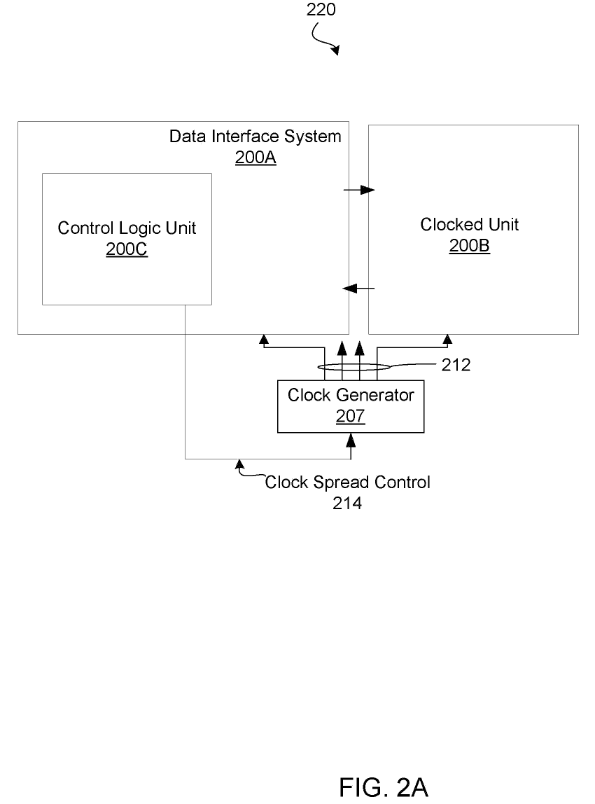

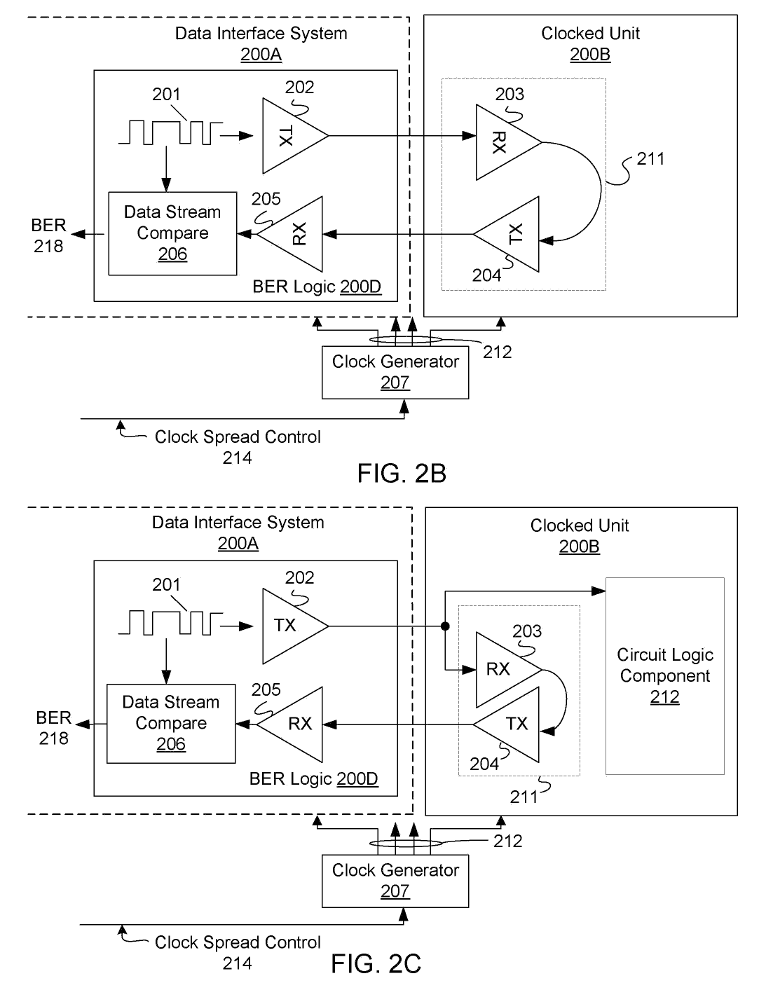

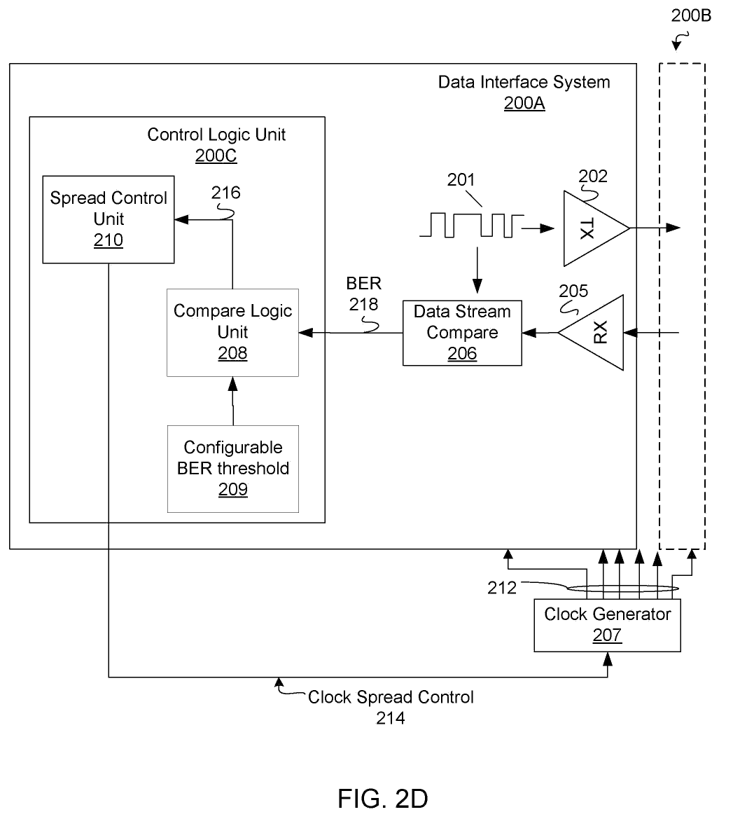

FIG. 2A shows a high level view of an electronic system 220 including a data interface system 200A, clocked unit 200B, and control logic unit 200C. A spread spectrum clock signal 212 is a signal for subcomponents of the invention. Other embodiments may include a greater number of spread spectrum clock signals as is seen in, for example, large scale parallel computing systems.

FIG. 2B shows the data interface system 200A with BER logic 200D incorporated and the clocked unit 200B. An input bit stream 201 is transmitted by a data interface transmitter 202 to a wrap-back logic receiver 203. The input bit stream 201 may be test data generated by a pseudo-random pattern generator (PRPG) or may be functional data. Clocked unit 200B then retransmits (i.e., wraps back) via a wrap-back logic transmitter 204 the input bit stream to a data interface receiver 205. Together, the wrap-back logic receiver 202 and the wrap-back logic transmitter 204 form a wrap-back logic unit 211. Wrap back capability may also be achieved with wires, fiber optic cables, and the like. A data stream compare 206 compares the original input bit stream 201 to the retransmitted data from the data interface receiver 205 and any bits that are incorrect when compared with the original input bit stream are flagged as bit errors. The result is output as a BER 218. The clock generator 207 generates the spread spectrum clock signal 212 and is controlled via a clock spread control 214 as explained in further detail below. In some embodiments, the clock generator 207 synchronizes all the elements across the data interface system 200A and the clocked unit 200B. Alternatively, clock synchronization can be achieved between different system components through the use of a phase locked loop (PLL) or delay locked loop (DLL).

FIG. 2C shows an alternative embodiment of a data interface system 200A with the wrap-back logic unit 211 in parallel with a circuit logic component 212 wherein the wrap back logic unit 211 can be set to ON or OFF (not shown) after electromagnetic emission and BER testing has been conducted. In some embodiments, wrap-back logic 211 is kept ON so that the spread spectrum clock signal is dynamically adjusted, either periodically or constantly, during operation of the electronic system 220.

FIG. 2D shows additional logic function added to the data interface system 200A. The compare logic unit 208 compares the BER 218 of the data interface system to the configurable BER threshold 209. In some embodiments, the configurable BER threshold 209 can be configured by a user. In an alternative embodiment, the configurable BER threshold 209 can be pre-set based on established bus interface standards for the maximum BER to satisfy system component requirements. The compare logic unit 208 determines if the BER 218 is below the configurable BER threshold 209 and the compare logic unit output 216 is a bit which is set to true when the BER 218 is above the configurable BER threshold 209 or false if below the configurable BER threshold 209. The compare logic unit output 216 controls a spread control unit 210 to indicate to the clock generator 207 to adjust the amount of spread on the spread spectrum clock signal 212. The spread control unit 210 signals to the clock generator 207 to incrementally widen the range of spreading on the spread spectrum clock signal 207 and retests the BER 218 of the data interface system. If the BER 218 exceeds the configurable BER threshold 209, the spread control unit 210 reduces the amount of spreading on the clock signal

In an alternative embodiment, the compare logic unit output 216 is a multi-bit word. The multi-bit word indicates the magnitude of how far BER is above the configurable BER threshold 209 or the magnitude of how far BER is below the configurable BER threshold 209. The multi-bit word signals to the spread control unit 210 the amount by which to adjust the range of spread on the clock signal 207. The spread control unit 210 indicates to the clock generator 207 to adjust the clock spread range accordingly.

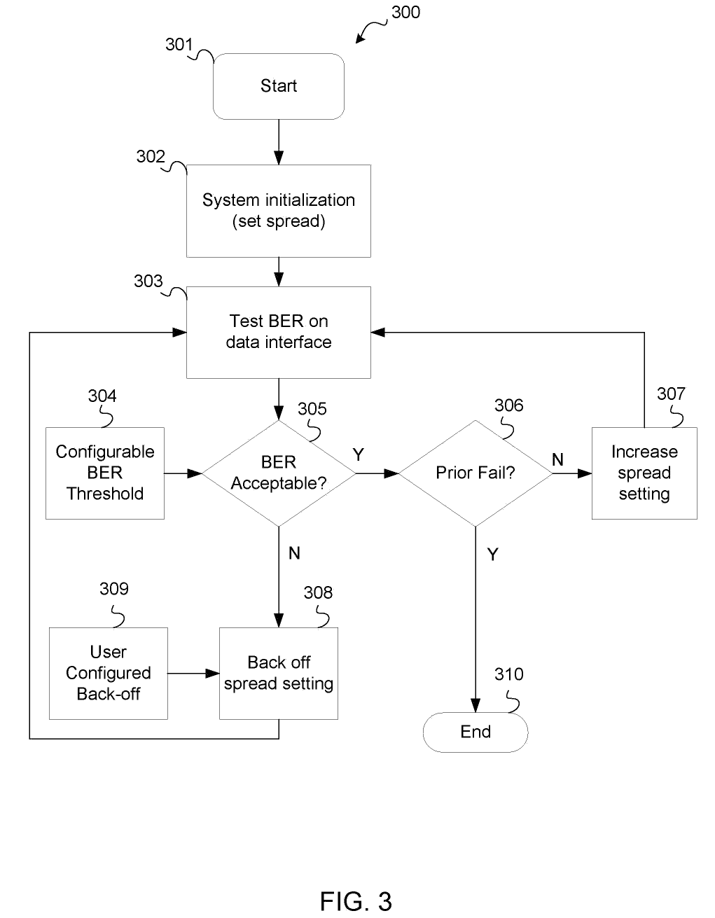

FIG. 3 shows a flowchart of a method embodiment 300 of the invention. Method 300 starts at step 301. In step 302, the system initializes by setting a starting value of frequency spread on one or more clocks. In step 303, the BER on the data interface is tested. Step 304 passes the configurable BER threshold to step 305. In step 305, the BER on the data interface is compared with the configurable BER threshold to determine if the BER is acceptable. If step 305 determines that the BER is not acceptable control passes to step 308. Step 308 sets Prior_Fail=1 and narrows the clock spread by an amount. Clock spread can be narrowed either by a fixed amount or alternatively as configured by a user configured backoff 309. In some embodiments, the back-off increment can be determined based on previously successful back-off increments. In other embodiments, the back off increment can be a function of the BER. After the clock frequency range has been narrowed, control is passed to step 303 in which the BER on the data interface is retested.

If the BER is acceptable control passes to step 306 in which a check is made to see if there has been a prior fail. If there has been no prior fail (Prior_Fail=0) in step 306 control passes to step 307 in which the spread setting is increased. In some embodiments, the Prior_Fail bit is periodically reset to “0” to account for changing conditions in the electronic system. After the clock frequency spread is increased, control is passed to step 303 in which the BER on the data interface is retested. If there has been a prior fail then control passes to step 310, the end of method 300.

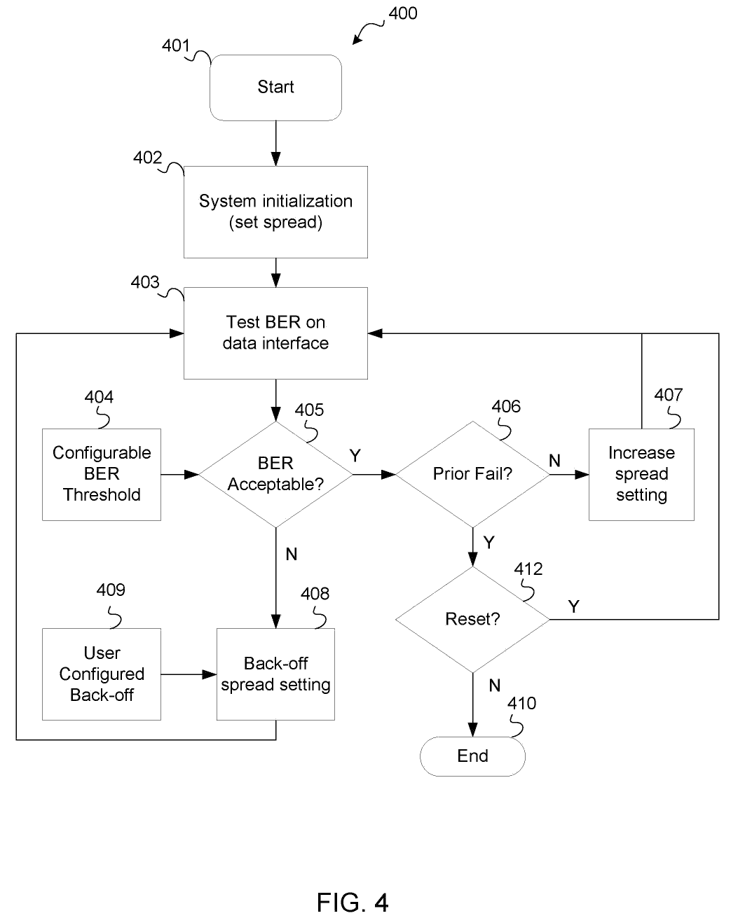

FIG. 4 shows a flowchart of an alternative method embodiment to FIG. 3 with an added step 412 of a reset. In step 412, the system determines if a set amount of time has elapsed and if so control passes to step 403. In some embodiments, the elapse time is user configured. In other embodiments the elapse time is pre-set. In an alternative embodiment, the system determines the reset based on whether changes have been made to components of the electronic system. If the threshold for the reset has not been crossed control is passed to step 410, the end of method 400.

What is claimed is:

1. An apparatus configured to adjust a spread spectrum on a clock in response to a bit error rate (BER) determination.

2. The apparatus of claim 1, wherein the apparatus comprises:
a data interface system, configured to measure the BER and has a BER output;
a compare logic unit configured to compare the BER output from the data interface system to a BER threshold; and
a spread control unit coupled to the compare logic unit, the spread control unit configured to control a clock frequency range, responsive to the output of the compare logic unit.

3. The apparatus of claim 2, wherein the compare logic unit is configured to set a failure bit set to true if the BER is above the BER threshold.

4. The apparatus of claim 2, wherein the compare logic unit is configured to set a failure bit to false if the BER is below the BER threshold.

5. The apparatus of claim 2, wherein the spread control unit is configured to narrow the clock frequency range if the compare logic unit indicates that the BER is above the BER threshold.

6. The apparatus of claim 5, wherein the spread control unit is configured to narrow the clock frequency range by a user defined incremental amount.

7. The apparatus of claim 5, wherein the spread control unit is configured to narrow the clock frequency range by a pre-set incremental amount.

8. The apparatus of claim 2, wherein the spread control unit is configured to widen the clock frequency range if the compare logic unit indicates that the BER is below the BER threshold.

9. The apparatus of claim 8, wherein the spread control unit is configured to widen the clock frequency range by a user defined incremental amount.

10. The apparatus of claim 8, wherein the spread control unit is configured to widen the clock frequency range by a pre-set incremental amount.

11. The apparatus of claim 2, wherein the spread control unit is configured to adjust the clock frequency range by a user defined incremental amount.

12. The apparatus of claim 2, wherein the spread control unit is configured to adjust the clock frequency range as a function of the BER.

13. The apparatus of claim 2, wherein the compare logic unit is configured to output a multi-bit word.

14. The apparatus of claim 13, wherein the multi-bit word is configured to indicate to the spread control unit the range and direction of spread spectrum clock adjustment.

15. The apparatus of claim 2, wherein the BER threshold is set by a user.

16. The apparatus of claim 2, wherein the BER threshold is pre-set to a maximum BER limit as defined by system component requirements.

17. The apparatus of claim 2, wherein the data interface system is configured to transmit an input data stream to a wrap back logic unit, the wrap back logic unit configured to retransmit the input data stream to a receiver on the data interface system.

18. The apparatus of claim 8, wherein the wrap back logic unit is in parallel with a circuit logic component.

19. A method comprising:
adjusting the frequency range of a spread spectrum clock such that a BER is less than a BER threshold.

20. A method comprising:
initializing a frequency range of a clock in a spread spectrum controller to a first frequency range
adjusting the frequency range of the clock with the spread spectrum controller;
measuring a bit error rate (BER) of a data interface, wherein the BER is correlated to the adjustment of the frequency range;
comparing said BER to a BER threshold;
modifying an output signal of said spectrum controller based on whether the BER is greater than the BER threshold; and,
repeating the adjusting, measuring, comparing, and modifying steps until said frequency range is widest such that said BER is below said BER threshold.
